(19) United States
(12) Patent Application Publication
(10) Pub. No.: US 2011/0145809 A1
(43) Pub. Date: Jun. 16, 2011

(54) METHOD AND APPARATUS FOR UPGRADING SOFTWARE IN CUSTOMER PREMISE EQUIPMENT

(75) Inventor: Doo-Il HWANG, Seoul (KR)

(73) Assignee: Samsung Electronics Co. Ltd., Suwon-si (KR)

(21) Appl. No.: 12/966,277

(22) Filed: Dec. 13, 2010

(30) Foreign Application Priority Data
Dec. 15, 2009 (KR) 10-2009-0124934

(51) Int. Cl. G06F 9/44; G06F 15/177

(52) U.S. Cl. 717/173; 713/2

(57) ABSTRACT

A method and apparatus for upgrading software in a Customer Premise Equipment (CPE) that exchanges Inform messages with a server over an Internet Protocol (IP) network are provided. The software upgrade method includes, upon receiving a download request message from an Automatic Configuration Server (ACS) remotely controlling the CPE, rebooting in an upgrade mode after storing upgrade execution information included in the download request message, acquiring a software image for upgrade from an upgrade server based on the stored upgrade execution information after rebooting in the upgrade mode, updating an old software image with the acquired software image, and rebooting in a normal mode after completing the update of the old software image.

### PRIORITY

This application claims the benefit under 35 U.S.C. §119(a) of a Korean patent application filed in the Korean Intellectual Property Office on Dec. 15, 2009 and assigned Serial No. 10-2009-0124934, the entire disclosure of which is hereby incorporated by reference.

### BACKGROUND OF THE INVENTION

1. Field of the Invention

The present invention relates generally to an upgrade method and apparatus. More particularly, the present invention relates to a method and apparatus for upgrading software in a Customer Premise Equipment (CPE) that exchanges Inform messages with a server over an Internet Protocol (IP) network.

2. Description of the Related Art

Based on advances in communication technologies, there is a growing interest in using communication technology for connecting general home information appliances to a network. Accordingly, many technologies have been developed to connect home information appliances to an external device such, as a server of a mobile service operator network, over an Internet Protocol (IP) network, and to manage the information appliances. To securely and reliably provide such network technologies, information security technology should be employed and technology for an interface between different devices should be standardized to realize reliable/compatible/interactive networks.

Organizations for standardization of such technologies include a Digital Subscriber Line (DSL) forum, International Telecommunication Union Telecommunication Standardization Sector (ITU-T), and a Digital Living Network Alliance (DLNA) forum. Among these organizations, the DSL forum, which has proposed Technical Report (TR)-069 as a standardized protocol, is the leading organization.

TR-069, which is a technology that has recently achieved worldwide attention, realizes a method of comprehensively controlling and managing Customer Premise Equipments (CPEs) existing in the home, such as a DSL modem, an Internet gateway device, and a Set-Top Box (STB), over an Automatic Configuration Server (ACS) or a remote control server.

Conventionally, a Simple Network Management Protocol (SNMP) has been widely used to control CPEs by means of an external remote device. However, as it is not standardized, a Management Information Base (MIB) data configuration is different for every service provider, and its security is somewhat vulnerable. Thus, technology transitions are being made to the TR-069 technology. Therefore, many service providers now use the TR-069 technology.

### SUMMARY OF THE INVENTION

An aspect of the present invention is to address at least the above-mentioned problems and/or disadvantages and to provide at least the advantages described below. Accordingly, an aspect of the present invention is to provide an upgrade apparatus and method for a Customer Premise Equipment (CPE).

Another aspect of the present invention is to provide an apparatus and method for upgrading a CPE using Download messages.

In accordance with an aspect of the present invention, a method is provided for upgrading software in a CPE. The method includes, upon receiving a download request message from an Automatic Configuration Server (ACS) that remotely controls the CPE, rebooting in an upgrade mode after storing upgrade execution information included in the download request message, after rebooting in the upgrade mode, acquiring a software image for upgrade from an upgrade server based on the stored upgrade execution information, updating an old software image with the acquired software image, and rebooting in a normal mode after completing the update of the old software image.

In accordance with another aspect of the present invention, an apparatus is provided for upgrading software in a CPE. The apparatus includes a memory for storing a software image for operating the CPE, and a controller for, upon receiving a download request message from an ACS, for rebooting in an upgrade mode after storing upgrade execution information included in the download request message, for updating an old software image stored in the memory with a software image for upgrade, acquired from an upgrade server based on the stored upgrade execution information after rebooting in the upgrade mode, and for rebooting in a normal mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a configuration of a network among Customer Premise Equipments (CPEs) based on Technical Report (TR)-069 technology, an Automatic Configuration Server (ACS) for managing the CPEs, and an upgrade server for storing information for upgrade of the CPEs, according to an exemplary embodiment of the present invention;

FIG. 2 is a signaling flow diagram among an ACS, a CPE, and an upgrade server to upgrade the CPE according to an exemplary embodiment of the present invention;

FIG. 3 is a flowchart illustrating a SoftWare (S/W) upgrade method in a CPE according to an exemplary embodiment of the present invention; and

FIG. 4 is a block diagram of a CPE according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A Customer Premise Equipment (CPE) according to an exemplary embodiment of the present invention denotes equipment installed in the home, and refers to a device capable of accessing an Internet Protocol (IP) network and providing a service to a user, such as a set-top box and a Digital Subscriber Line (DSL) modem.

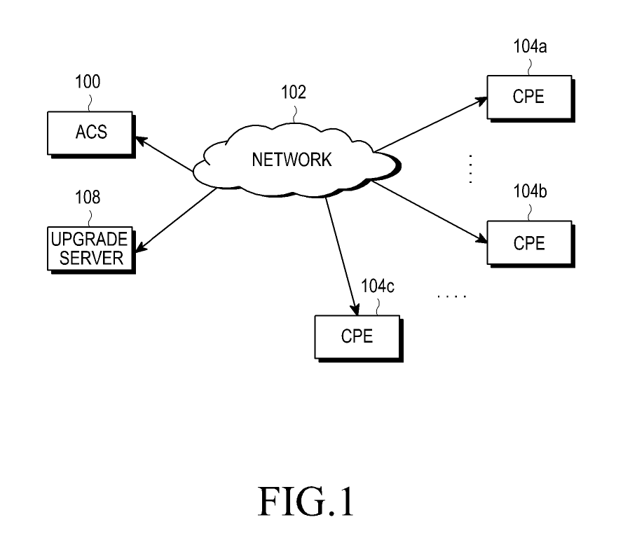

FIG. 1 illustrates a configuration of a network among CPEs based on Technical Report (TR)-069 technology, an Automatic Configuration Server (ACS) for managing the CPEs, and an upgrade server for storing information for upgrade of the CPEs according to an exemplary embodiment of the present invention.

Referring to FIG. 1, the ACS 100 remotely manages CPEs 104a, 104b and 104c over an IP network 102 in accordance with the TR-069 standard, and is constructed in a service operator network. The CPEs 104a, 104b and 104c each receive a request, which is sent by the ACS 100 using a remote invocation method, perform a process appropriate thereto, and inform the ACS 100 of the processing results. The ACS 100 exchanges messages with the CPEs 104a, 104b and 104c using a Hyper Text Transfer Protocol (HTTP) or a Hyper Text Transfer Protocol over Secure (HTTPS), which is a security-enhanced HTTP.

The ACS 100 exchanges Inform Request/Response messages with the CPEs 104a, 104b and 104c, in order to periodically monitor information about the CPEs 104a, 104b and 104c and to control them as defined in the TR-069 standard. The Inform Request/Response messages defined in TR-069 are important messages that the ACS 100 should exchange with the CPEs 104a, 104b and 104c to perform communication. Regarding the CPEs 104a, 104b and 104c shown in FIG. 1, it is to be understood that any number of CPEs may be installed in a home, office, and the like.

When starting communication, the ACS 100 and the CPEs 104a, 104b and 104c exchange Inform messages with each other. In this application, ‘Information message exchange’ refers to a process in which the ACS 100 and the CPEs 104a, 104b and 104c exchange an Inform Request message and an Inform Response message. Upon success in exchanging Inform messages with the CPEs 104a, 104b and 104c, the ACS 100 performs a series of message exchange processes to perform desired functions, such as requesting SoftWare (S/W) upgrade information (e.g., upgrade start notification information) and CPE information and providing appropriate solutions to the CPEs in trouble. Meanwhile, a transmission period of an Inform Request message is remotely set for each CPE by the ACS 100, and each CPE stores and manages the set value in its memory.

When an S/W upgrade for the CPEs 104a, 104b and 104c should be performed, the ACS 100 and the CPEs 104a, 104b and 104c perform an actual upgrade procedure by exchanging Download messages after exchanging Inform messages. More particularly, in the case where CPEs 104a, 104b and 104c are Set Top Boxes (STBs), if an S/W upgrade request is received while a broadcast is being viewed, a user should stop viewing the broadcast which results in an inconvenience. Therefore, it is preferable for the ACS 100 to perform an S/W upgrade for the CPEs 104a, 104b and 104c at a time during which the user does not receive services through the CPEs 104a, 104b and 104c.

For an S/W upgrade of the CPEs 104a, 104b and 104c, the TR-069 protocol as explained with reference to FIG. 1, defines a method for the ACS 100 to remotely call or invoke the CPEs 104a, 104b and 104c using a Download Request message and a Download Response message. Referring to FIG. 1, after exchanging Inform messages with the CPEs 104a, 104b and 104c, the ACS 100 sends a Download Request message to a CPE(s) for which an S/W upgrade should be performed. Upon receiving the Download Request message, a CPE accesses an upgrade server 108 in which new software for the upgrade is stored, and downloads a software image for the upgrade from the upgrade server 108, based on information included in the Download Request message.

According to exemplary embodiments of the present invention, procedures for performing CPE upgrade among the ACS 100, the CPEs 104a, 104b and 104c, and the upgrade server 108, connected over an IP network, in accordance with the TR-069 protocol are defined, and operations of the ACS, the CPE and the upgrade server to perform these procedures will be described.

Exemplary embodiments of the present invention are implemented as Inform messages are exchanged in the environment including an ACS existing in a service operator network and a CPE connected to the ACS over an IP network, such as an STB existing in the home. In the case where the CPE is an STB, the CPE performs not only the basic broadcast transmission/reception function, but also a function in which the CPE receives a request, which is sent by an ACS using a remote invocation method, performs a process appropriate thereto, and then informs the ACS of the processing results. The CPE exchanges Inform Request/Response messages with the ACS using an HTTP or an HTTPS, which is a security-enhanced HTTP.

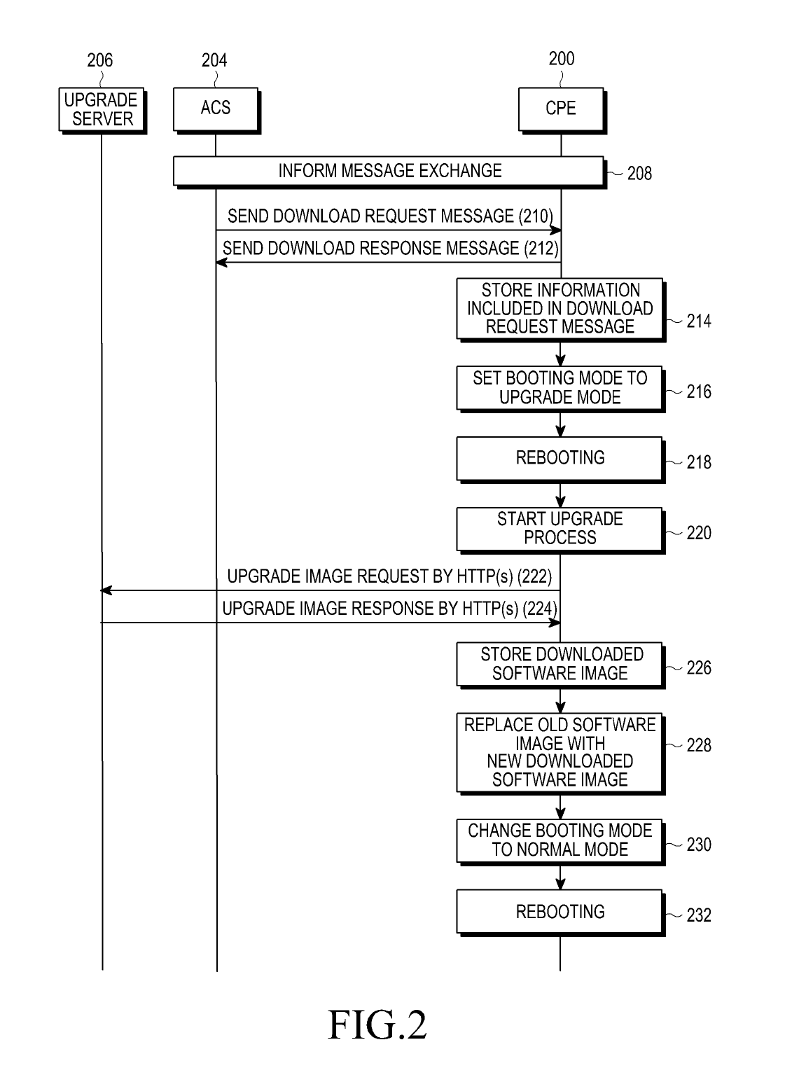

A signaling flow among a CPE 200, an ACS 204, and an upgrade server 206 according to an exemplary embodiment of the present invention will now be described below with reference to FIG. 2.

FIG. 2 is a signaling flow diagram among an ACS, a CPE, and an upgrade server to upgrade the CPE according to an exemplary embodiment of the present invention.

Referring to FIG. 2, in step 208, the CPE 200 exchanges Inform messages with the ACS 204. Considering the network load and user inconvenience, it is preferable to perform an S/W upgrade for the CPE 200 when the CPE 200 is not providing a service, i.e., when the CPE 200 is in a power standby state.

However, exemplary embodiments of the present invention may perform an S/W upgrade regardless of whether the CPE 200 is in a power standby state or an active state.

In the Inform message exchange process of step 208, the CPE 200 sends an Inform Request message to the ACS 204 and receives an Inform Response message from the ACS 204 in response thereto.

If it is determined in step 208 that an S/W upgrade for the CPE 200 should be performed, the ACS 204 having exchanged Inform messages with the CPE 200 sends a Download Request message to the CPE 200 in step 210. The ACS 204 may determine whether an S/W upgrade for the CPE 200 should be performed based on information (e.g., software version information) included in the Inform Request message which was received from the CPE 200 in the Inform message exchange step 208.

The Download Request message sent in step 210 may include information given in Table 1 below.

TABLE 1

| Information | |
|---|---|
| Content | Description |
| Download | Information about an address where a software image for |
| request URL | upgrade by CPE is stored (i.e., information about an |
| | address from which software image for upgrade by CPE |
| | is to be fetched. |
| User name | User Identifier (ID) information used for user |
| | authentication. |
| Password | User password information used for user authentication. |
| Delay | Time for which CPE should wait until it starts upgrade |
| seconds | after receiving Download Request message. |

Upon receiving the Download Request message in step 210, the CPE 200 sends a Download Response message in response thereto in step 212. In step 214, the CPE 200 stores information included in the Download Request message. The CPE 200 sets its booting mode to an upgrade mode in step 216, and reboots in step 218 to perform an upgrade procedure in the upgrade mode. After rebooting in step 218, the CPE 200 starts an upgrade process in step 220, and sends a request for an upgrade image to the upgrade server 206 existing in the service operator network using information included in the received Download Request message in step 222. In step 224, the CPE 200 fetches or downloads a software image for upgrade through an HTTP(S)-based upgrade image response process. In an exemplary implementation of steps 222 and 224, the CPE 200 may fetch a desired software image for upgrade from the upgrade server 206 using a GET command defined in the HTTP.

Upon fetching the software image for upgrade from the upgrade server 206, the CPE 200 stores the downloaded software image in step 226, and updates the old software image with the downloaded software image in step 228. The CPE 200 changes its booting mode to a normal mode in step 230, and reboots in the normal mode in step 232. After the rebooting in step 232, the CPE 200 will operate with the upgraded software.

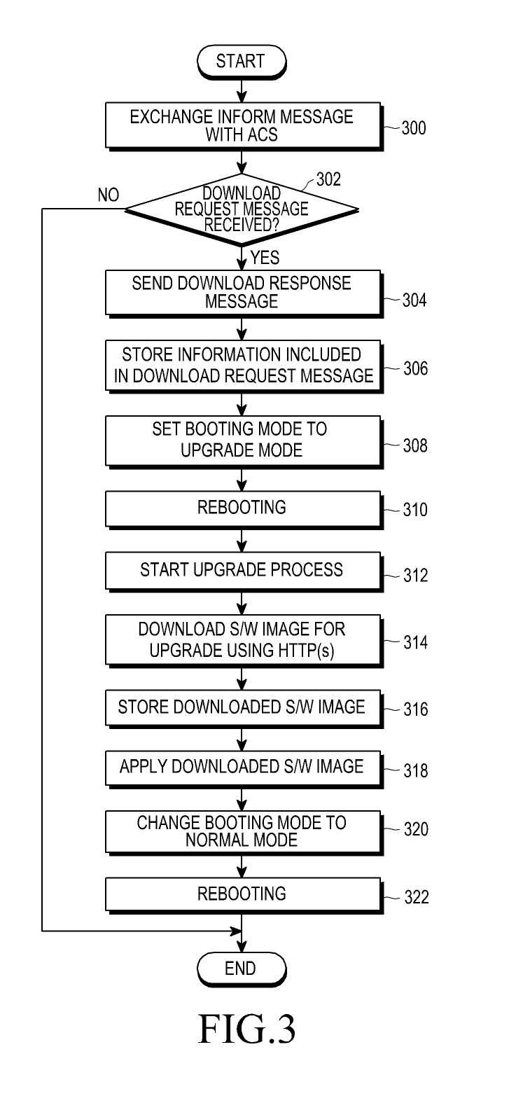

FIG. 3 illustrates an S/W upgrade method in a CPE according to an exemplary embodiment of the present invention.

Referring to FIG. 3, the CPE 200 exchanges Inform messages with the ACS 204 in step 300, and determines in step 302 whether a Download Request message is received from the ACS 204. Upon receiving the Download Request message in step 302, the CPE 200 sends a Download Response message to the ACS 204 in response thereto in step 304.

In step 306, the CPE 200 stores information (e.g., Download Request Uniform Resource Location (URL) information, User name, Password information, etc. in Table 1) included in the Download Request message. The CPE 200 sets its booting mode to an upgrade mode in step 308, and reboots in the upgrade mode in step 310. In an exemplary implementation of step 308, a controller of the CPE 200 may change a booting mode of the CPE 200 to an upgrade mode by setting a bootcode stored in a booting area of a memory as an upgrade mode. For example, the controller may change the boot mode to the upgrade mode by setting “BOOTCODE=UPGRADE” in the booting area of the memory. In a normal booting mode, the bootcode is set as “BOOTCODE=BOOT”.

After the rebooting in step 310, the CPE 200 operates not in the normal booting mode but in the upgrade mode, and starts an upgrade process in step 312. In step 314, the CPE 200 accesses the upgrade server 206 where a software image for upgrade is stored, using the information stored in step 306, and downloads the software image for upgrade using the HTTP or HTTPS. In step 316, the CPE 200 stores the downloaded software image. In step 314, the CPE 200 may identify a location (e.g., IP address or URL) of the upgrade server 206 where the software image for upgrade is stored, depending on the Download Request URL information, and may access the upgrade server 206 with the user ID and password, making it possible to fetch a software image from the upgrade server 206.

After storing the software image for upgrade in step 316, the CPE 200 applies the downloaded software image by replacing the old software image with the downloaded software image in step 318. The CPE 200 changes its booting mode back to the normal booting mode in step 320, and then reboots in the normal booting mode in step 322. In step 320, the controller of the CPE 200 may operate in the normal booting mode by setting the bootcode in the memory from the upgrade mode back to the normal booting mode. For example, the controller reboots in the normal booting mode by changing the boot code in the memory from “BOOTCODE=UPGRADE” to “BOOTCODE=BOOT”.

After the rebooting in step 322, the CPE 200 will perform different operations according to its state. For example, assuming that the CPE 200 was in a power standby state, after the rebooting in step 322, the CPE 200 will exchange specific parameters with the ACS 204 if needed, and then transition back to the power standby state. Otherwise, if the CPE 200 was in an active state, the CPE 200 will provide a service such as a broadcast service and an Internet service, to the user using the upgraded software.

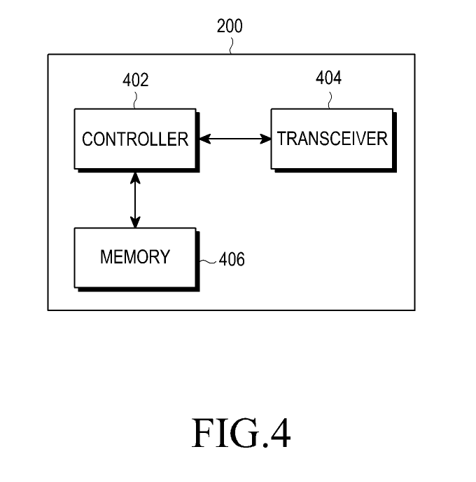

FIG. 4 is a block diagram of a CPE according to an exemplary embodiment of the present invention.

A block diagram of the CPE 200 according to an exemplary embodiment of the present invention will be described below with reference to FIG. 4.

Referring to FIG. 4, the controller 402 controls the overall operation of the CPE 200, and exchanges messages with the ACS 204 and the upgrade server 206 through a transceiver 404. That is, the controller 402 sends an Inform Request message and receives an Inform Response message in reply thereto through the transceiver 404. Upon receiving a Download Request message from the ACS 204 through the transceiver 404, the controller 402 sends a Download Response message to the ACS 204 through the transceiver 404 in reply thereto.

Upon receiving a Download Request message from the ACS 204, the controller 402 extracts upgrade execution information used to perform S/W upgrade, such as Download Request URL information, User name and Password, from the information included in the Download Request message, and stores the extracted information to the memory 406. ‘Delay seconds’ in Table 1 is not required to be stored in the memory 406 because it is discarded after use by the controller 402 before rebooting.

After storing the upgrade execution information, the controller 402 sets a bootcode defined in a booting area of the memory 406 to an upgrade mode. For example, the controller 402 sets the bootcode defined in the booting area of the memory 406 as “BOOTCODE=UPGRADE”, and then reboots. After setting the bootcode to an upgrade mode, the controller 402 may access the upgrade server 206 where a software image for upgrade is stored, depending on the Download Request URL in the upgrade execution information, and may download a software image for upgrade through the transceiver 404 using an HTTP GET method. The controller 402 replaces the old software image stored in the memory 406 with the downloaded software image for upgrade, by overwriting the downloaded new software image on the previous software image stored in the memory 406. The controller 402 controls the CPE 200 to boot in the normal booting mode by changing the bootcode in the memory 406 to the normal bootcode “BOOTCODE=BOOT” and rebooting in the normal booting mode. After rebooting in the normal booting mode, the CPE 200 provides a service. For example, upon receiving a Download Request message from the ACS 204, the controller 402 according to an exemplary embodiment of the present invention stores upgrade execution information included in the Download Request message, reboots in an upgrade mode, updates an old software image stored in the memory with a software image for upgrade, acquired from an upgrade server based on the stored upgrade execution information after rebooting in the upgrade mode, and then reboots in the normal mode.

The memory 406 may include a nonvolatile memory or a volatile memory, and the nonvolatile memory, such as a flash memory, may continue to store the old data even though the CPE 200 is powered off. In an exemplary embodiment of the present invention, the memory 406 stores upgrade execution information included in the Download Request message, and a software image acquired from the upgrade server 206.

While exemplary embodiments of the present invention have proposed an S/W upgrade method in a CPE using a TR-069 protocol, the invention may be applied to any equipment located in a subscriber's home, which uses an HTTP/HTTPS protocol, and downloads a software image for S/W upgrade from an external server over the IP network.

The above-described exemplary methods of the present invention may be embodied in a program and stored in a computer readable recording medium (e.g., Compact Disc-Read Only Memory (CD-ROM), Random Access Memory (RAM), floppy disk, hard disk, magneto-optical disk, flash memory, etc.). Such a process can be easily implemented by those of ordinary skill in the art.

As is apparent from the foregoing description, an upgrade procedure undefined in the TR-069 standard is defined according to exemplary embodiments of the present invention, enabling easy upgrade of a CPE.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for upgrading software in a Customer Premise Equipment (CPE), the method comprising:
upon receiving a download request message from an Automatic Configuration Server (ACS) that remotely controls the CPE, rebooting in an upgrade mode after storing upgrade execution information included in the download request message;
after rebooting in the upgrade mode, acquiring a software image for upgrade from an upgrade server based on the stored upgrade execution information;
updating an old software image with the acquired software image; and
rebooting in a normal mode after completing the update of the old software image.

2. The method of claim 1, wherein the upgrade execution information includes at least one of download request Uniform Resource Location (URL) information, a user name, and a password.

3. The method of claim 2, wherein the acquiring of the software image for upgrade comprises:
sending a request for the software image for upgrade to an upgrade server indicated by the download request URL information, using a Hyper Text Transfer Protocol (HTTP) or a Hyper Text Transfer Protocol over Secure (HTTPS); and
downloading the software image for upgrade from the upgrade server using the HTTP or HTTPS.

4. The method of claim 1, further comprising:
exchanging Inform messages with the ACS.

5. The method of claim 1, wherein the acquiring of the software image for upgrade comprises:
storing the acquired software image in a memory.

6. The method of claim 1, further comprising:
transmitting a download response message to the ACS in response to the download request message.

7. The method of claim 1, wherein the rebooting in the upgrade mode comprises:
setting a bootcode stored in a memory to the upgrade mode.

8. An apparatus for upgrading software in a Customer Premise Equipment (CPE), the apparatus comprising:
a memory for storing a software image for operating the CPE; and
a controller for, upon receiving a download request message from an Automatic Configuration Server (ACS), rebooting in an upgrade mode after storing upgrade execution information included in the download request message, for updating an old software image stored in the memory with a software image for upgrade, acquired from an upgrade server based on the stored upgrade execution information after rebooting in the upgrade mode, and for rebooting in a normal mode.

9. The apparatus of claim 8, wherein the upgrade execution information includes at least one of download request Uniform Resource Location (URL) information, a user name, and a password.

10. The apparatus of claim 9, wherein the controller sends a request for a software image for upgrade to an upgrade server indicated by the download request URL information, using a Hyper Text Transfer Protocol (HTTP) or a Hyper Text Transfer Protocol over Secure (HTTPS), and downloads the software image for upgrade from the upgrade server using the HTTP or HTTPS.

11. The apparatus of claim 8, wherein the controller exchanges Inform messages with the ACS.

12. The apparatus of claim 8, wherein the controller stores the acquired software image in the memory.

13. The apparatus of claim 8, wherein the controller transmits a download response message to the ACS in response to the download request message.

14. The apparatus of claim 8, wherein the controller reboots in the upgrade mode by setting a bootcode stored in a memory to the upgrade mode.
